(19) United States
(12) Patent Application Publication
(10) Pub. No.: US 2023/0285957 A1
(43) Pub. Date: Sep. 14, 2023

(54) PIPETTE TIP DEVICES AND METHODS

(71) Applicant: Agilent Technologies, Inc., Santa Clara, CA (US)

(72) Inventor: Richard Avidano, Santa Clara, CA (US)

(21) Appl. No.: 18/015,911

(22) PCT Filed: May 14, 2021
(86) PCT No.: PCT/US2021/032413

§ 371 Date: Jan. 12, 2023

Related U.S. Application Data
(60) Provisional application No. 63/050,970, filed on Jul. 13, 2020.

(51) Int. Cl. B01L 3/02

(52) U.S. Cl. CPC B01L 3/0279; B01L 2200/025; B01L 2200/0689

(57) ABSTRACT

Methods and apparatus are provided for attaching and detaching pipette tips with a pipettor and for storing pipette tips. A pipette comprises an aspiration block and one or more magnets fixed at the aspiration block face. A reusable pipette tip has a pipette adaptor comprising a magnetically attracted material. A pipetting device is provided which comprises a pipettor magnetically attached to a pipette tip. Methods of using foregoing apparatus are also provided.

### CROSS-REFERENCE TO RELATED APPLICATIONS

This application claims the benefit of U.S. Provisional Application No. 63/050,970, filed Jul. 13, 2020, the contents of which are fully incorporated herein by reference.

### FIELD OF THE INVENTION

The present disclosure relates generally to pipettors and pipette tips. The present disclosure also relates to methods and apparatus for attaching, using and removing pipette tips and for storing pipette tips.

### BACKGROUND OF THE INVENTION

Pipettors are utilized in laboratories and other settings for aspirating and dispensing precise volumes of liquid, typically by air displacement. A wide variety of pipettors are available and are capable of a wide variety of liquid handling functions. The pipettor includes a syringe or other aspiration block coupled with a pipette tip. The syringe includes a piston that moves through a barrel. The pipette tip is coupled to the syringe such that a flow path is established between the barrel and the pipette tip. The piston is driven manually or by a motor to alternately execute a forward stroke and backward stroke in the barrel. The forward stroke can be utilized to dispense liquid from the pipette tip, and the backward stroke creates suction and thus can be utilized to aspirate liquid into the pipette tip. One or more pipettors may be included in an automated pipetting device, which may be part of a liquid handling apparatus that includes liquid containers with a variety of different liquids.

Disposable pipette tips have been used with pipettors for decades. A laboratory may use thousands of pipette tips to aspirate and/or dispense samples and reagents in its various analytical procedures. If the laboratory is not able or willing to reuse the pipette tips, the pipette tips are discarded after each use. The use of disposable pipette tips increases costs and efforts for those laboratories as they are required to continually purchase and restock pipette tips, and the discarded pipette tips increase the amount of waste generated. As laboratories strive to increase the number of samples processed and analyzed, the costs and waste due to disposing of pipette tips can become significant. There are also many applications where molded plastic disposable pipette tips do not have adequate properties for the application. This drives the need to use more expensive tips made from metal, ceramic, etc. which are not disposable. With non-disposable tips comes the need to wash them in between handling of different samples.

Pipette tips are available in many different sizes (e.g., 10 μL, 50 μL, 300 μL, 1 mL, 5 mL, etc.) and geometries, including both disposable and non-disposable types. Different procedures or protocols may require different pipette tips (in terms of size and/or type), and in some cases the same procedure or protocol may require the use of different pipette tips. Some existing pipetting devices have the ability to accommodate different styles of pipette tips, but require a user to manually change pipette tips between automated procedures or protocols. Some existing pipetting devices have the ability to automatically change disposable tips and non-disposable tips during a procedure or protocol, but require the ends of those pipette tips (which are to be coupled to the syringes) to have the same interface geometry. To accommodate disposable pipette tips sized to hold large volumes (e.g., 1000 μL), the interface geometry may be designed around those large tips. Thus, smaller volume disposable tips (e.g., 10 μL) must use the same interface to the pipettor as is used by the much larger tips, resulting for instance in a smaller volume tip that is not optimally designed for its small volume and use or application. For example, the interface of the smaller volume tip may be much larger than desired. Moreover, because the interface on the smaller volume tips is forced to be large (again, to be interchangeable with larger volume tips in conjunction with the same pipettor), the smaller volume tips cannot be placed in a grid next to each other at the relatively small spacing (e.g., 4.5 mm) required to access the adjacent wells of a multi-well (e.g., 384 well) plate of standard size. In addition, different procedures or protocols may require the use of multi-channel pipetting devices and/or single-channel pipetting devices. These two types of pipetting devices often have different interfaces, and thus the same size or type of pipette tip may not be usable on both a multi-channel pipetting devices and a single-channel pipetting devices.

Generally, there is an ongoing need for increasing the level of automation provided by liquid handling and pipetting devices to increase throughput and the “walk away” time afforded to users of such instruments. In particular, there is a need for increasing the level of interchangeability among different types and sizes of pipette tips, and for automating the tasks of coupling pipette tips to syringes, decoupling pipette tips from syringes, and exchanging different pipette tips in an automated manner. There is a need for an automated and highly reliable method for attaching, removing and storing pipette tips so they may be reused in laboratory processes.

### SUMMARY OF THE INVENTION

As an aspect of the present invention, a pipettor is provided. The pipettor comprises an aspiration block comprising an aspiration channel and an aspiration block end, wherein the aspiration channel comprises an opening at the aspiration block end. The pipettor also comprises one or more magnets fixed in the aspiration block at the aspiration block end.

As another aspect of the present invention, a reusable pipette tip is provided. The pipette tip comprises a pipette adapter that has an adapter proximal end, an adapter distal end, an adapter side, and an adapter bore having openings at the adapter proximal end and the adapter distal end. The adapter side comprises an adapter radial groove. The pipette adapter also comprises a magnetically attracted material. The reusable pipette tip also comprises a pipette tube that has a pipette tube proximal end and a pipette tube distal end. The pipette tube proximal end is fixed in the central bore opening at the adapter distal end.

As another aspect of the present invention, a pipetting device is provided. The pipetting device comprises a pipettor and a reusable pipette tip. The pipettor comprises an aspiration block comprising an aspiration channel and an aspiration block end, wherein the aspiration channel comprises an opening at the aspiration block end. The pipettor also comprises one or more magnets fixed in the aspiration block at the aspiration block end. The reusable pipette tip comprises a pipette adapter that has an adapter proximal end, an adapter distal end, an adapter side, and an adapter bore having openings at the adapter proximal end and the adapter distal end. The adapter side comprises an adapter radial groove. The pipette adapter comprises a magnetically attracted material. The reusable pipette tip also comprises a pipette tube comprising a pipette tube proximal end and a pipette tube distal end. The pipette tube proximal end is fixed in the central bore opening at the adapter distal end. The pipette tip is magnetically attached to the pipettor so as to provide a substantially liquid-tight flow path between the aspiration channel and the pipette tip channel.

As another aspect of the present invention, a method of using a reusable pipette tip with a pipettor is provided. The method comprises providing a pipettor that has an aspiration block with an aspiration channel and an aspiration block end. The aspiration block also comprises one or more magnets fixed in the aspiration block at the aspiration block end. The method also includes placing the aspiration block end sufficiently close to a reusable pipette tip to form a magnetic attachment. The reusable pipette tip comprises a pipette adapter that has a magnetically attracted material, as well as an adapter proximal end, an adapter distal end, and an adapter bore. The reusable pipette tip also comprises a pipette tube comprising a pipette tube proximal end and a pipette tube distal end. The pipette tube proximal end is fixed in the central bore opening at the adapter distal end. The pipette tip is magnetically attached to the pipettor so as to provide a substantially liquid-tight flow path between the aspiration channel and the pipette tip channel.

These and other features and advantages of the present apparatus and methods will be apparent from the following detailed description, in conjunction with the appended claims.

### BRIEF DESCRIPTION OF THE DRAWINGS

FIGS. 1A and 1B illustrate an exemplary embodiment of a pipettor.

FIG. 2 illustrates an exemplary embodiment of a pipetting device that comprises a pipettor and a reusable pipette tip.

FIG. 3 is a view of an exemplary embodiment of a pipette tip magnetically attached to a pipettor.

FIG. 4 is a view of another exemplary embodiment of a pipette tip magnetically attached to an aspiration block of a pipettor.

FIG. 5 is a view of an exemplary embodiment of a pipette tip which is magnetically attached to an aspiration block.

FIG. 6 is a view of another exemplary embodiment of a pipette tip magnetically attached to an aspiration block of a pipettor.

FIG. 7 is a view of an exemplary embodiment of a pipette tip magnetically attached to an aspiration block of a pipettor.

FIGS. 8A and 8B illustrate a pipetting system comprising a pipette tip storage device configured for holding one or more pipette tips.

The present teachings are best understood from the following detailed description when read with the accompanying drawing figures. The features are not necessarily drawn to scale.

### DETAILED DESCRIPTION

Some embodiments of the present apparatus and methods provide for easy and rapid attachment and detachment of a reusable pipette with a pipettor. In some embodiments, among other advantages, pipette tips are held firmly in place during use, and the seal between the pipette adapter and the aspiration block of a pipettor is substantially gas- and liquid-tight and has minimized dead volume. In some embodiments of the pipetting systems, Pipette tips can be retrieved from a pipette tip storage location and returned to the same location or to a different location if desired. In some embodiments, the magnetic attachment mechanism employed in the present apparatus can accommodate potential errors in location of the pipette tip with respect to a pipette tip storage device, including, for example, errors of +/−0.75 mm in the X and Y directions as the pipette tip is placed in the storage device.

As one aspect, novel pipettors comprise an aspiration block and one or more magnets. The magnets are fixed in the aspiration block at the aspiration block end. In some embodiments, the magnets are recessed from the aspiration block face, so the magnets do not physically contact a pipette tip when it is magnetically attached to the pipettor. Any suitable magnets may be used, including, for example, small but powerful neodymium iron boron magnets, and they may be located in the aspiration block face. The aspiration block can comprise stainless steel in whole or in part, or other material, and it can include a tube or other aspiration channel. The magnets should be strong enough to pickup and securely hold the pipette tip. In some embodiments, the magnets are strong enough to compress a compliant material positioned to form a seal between the aspiration block and the pipette tip.

In some embodiments, the pipettor is adapted for transferring fluids by pipetting, including, for example, aspirating or dispensing fluids in volumes from 10 μl to 500 μl. A pipettor can also be adapted for mixing fluids in mixing strips; changing a pipette tip; detecting liquid levels; and delivering water or solvent to a slide processing module, humidifier pad, or mixing strip for adjusting humidity. In some embodiments, the pipettor comprises one or more features adapted for washing the inside of a pipette tip. A pipettor may interface with one or more, or all, of a processing module, a wash station, a pipette tip storage station, a reagent vial storage, and a gantry.

The present methods and apparatus can include a pipettor that has a pipette tip. In some embodiments, the pipette tip is a disposable or reusable pipette tip. Reusable pipette tips require washing between uses to avoid contamination. It is also contemplated that the present methods and apparatus may be used with disposable pipette tips, thereby reducing cost and waste from replacing a pipette tip after a single use.

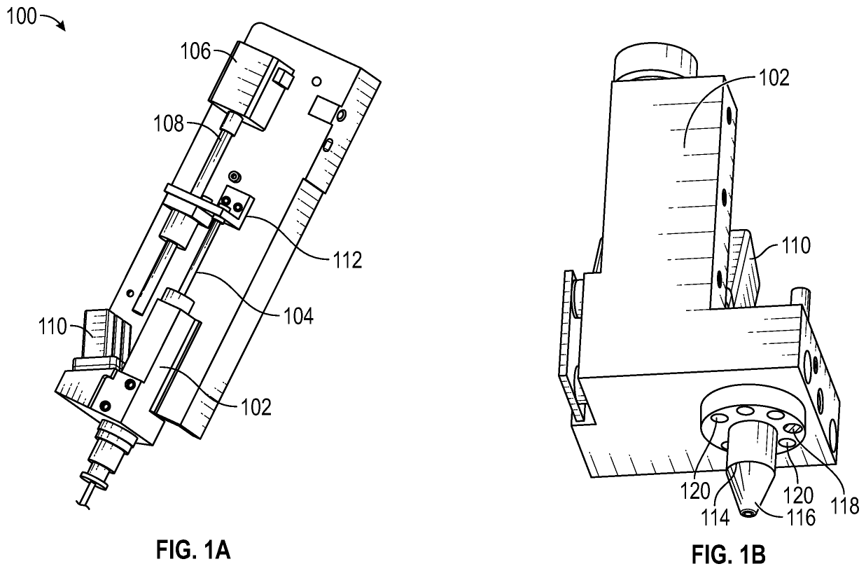

FIG. 1A illustrates an exemplary embodiment of a pipettor. The pipettor 100 comprises an aspiration block 102, and a piston 104 which controls movement of fluids in and out of aspiration block 102. The piston 104 can be actuated by any suitable mechanism. In FIG. 1A, it is actuated by a motor 106 that spins a lead screw 108, which moves a stage 112, thereby causing the piston 104 to move up and down. The piston 104 is moved up to aspirate a fluid into the aspiration block and down to dispense the fluid out of the pipettor. The pipettor 100 also comprises a valve pack 110 for controlling which fluids are provided to the aspiration block 102. In some embodiments, the pipettor is configured to deliver at least two types of liquids to the pipette tip. For example the pipettor can be configured to deliver one or more reagents or washing fluids. Pressurized air or other gas can be delivered by the aspiration block to the inside of the tip. The pressurized gas can be provided at two different flow rates (low & high) to perform different steps or functions.

FIG. 1B provides another view of the aspiration block 102. One or more liquids and/or one or more pressurized gases can enter the aspiration block 102 from conduits, valves or other routes. In FIG. 1B, a valve pack 110 controls delivery of the reagents, washing fluids, pressurized gas, and other fluids (such as solvents and buffers) to the aspiration block 102. When fluids are delivered through the aspiration block 102, they pass through its outlet 114 and to an attached pipette tip. The outlet 114 of the aspiration block 102 can comprise a tapered cone 116 to facilitate attachment of a pipette tip.

In some embodiments, a pipette tip attaches to a pipettor by use of one or more magnets 120, for example six magnets arranged in a circle as affixed to the aspiration block, such as by an adhesive. The apparatus can include a seal material (e.g., O-ring seals) between the pipette tip and a nipple of the aspiration block of the pipettor. The tapered cone 116 can have a recess for an O-ring or other seal material. A pipette tip sensor 118 can be positioned to sense whether a pipette tip is present or attached to the aspiration block 102 and provide a signal to a controller to allow or halt the flow of fluid from the pipettor to the outlet 114.

In some embodiments, a pipettor can be automatically moved along one or more axis (X, Y, and/or Z axis) such as by operation of a gantry or other robotic device. The gantry and other devices can be positioned so that the pipettor can be moved horizontally and vertically to change the pipette tip, such as by moving up and down to separate a first pipette tip and attach a second pipette tip.

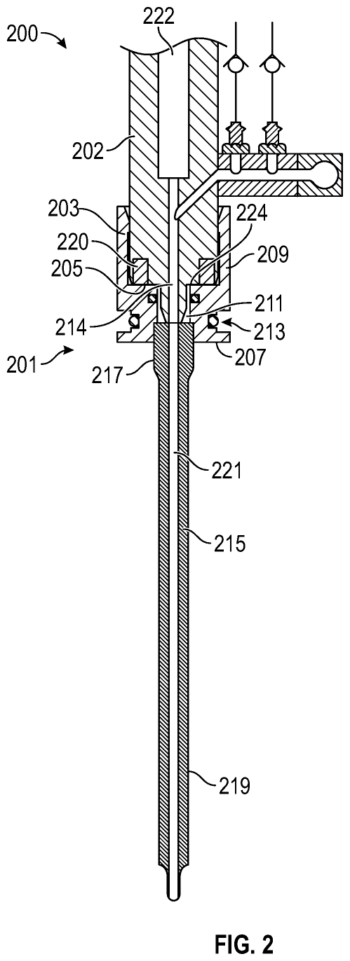

FIG. 2 illustrates the interior of an exemplary embodiment of a pipetting device that comprises a pipettor 200 and a reusable pipette tip 201. The pipettor 200 comprises an aspiration block 202 comprising an aspiration channel 222 and an aspiration block end 224, with an opening (outlet 214) at the aspiration block end 224. The pipettor 200 also comprises one or more magnets 220 fixed in the aspiration block 202 at the aspiration block end 224.

The pipetting device also comprises a reusable pipette tip 201, which comprises a pipette adapter 203 and a pipette tube 215. The pipette adapter 203 has an adapter proximal end 205, an adapter distal end 207, and an adapter side 209. The pipette adapter 203 also comprises an adapter bore 211 which has openings at the adapter proximal end 205 and the adapter distal end 207. The adapter side 209 of pipette adapter 203 comprises an adapter radial groove 213. The pipette adapter 203 comprises a magnetically attracted material, such as by being formed from such a material or containing an amount of such a material. The pipette tube 215 of the reusable pipette tip 201 comprises a pipette tube proximal end 217 and a pipette tube distal end 219. The pipette tube proximal end 215 is fixed in the adapter bore 211 opening at the adapter distal end 207. The pipette tip 201 is magnetically attached to the pipettor 200 so as to provide a substantially liquid-tight flow path between the aspiration channel 222 and the pipette tip channel 221.

As another aspect, reusable pipette tips are provided with a pipette adapter comprising a magnetically attracted material. The pipette adapter also comprises an adapter proximal end, an adapter distal end, an adapter side, and an adapter bore. In some embodiments, the adapter side comprises an adapter radial groove. The reusable pipette tip also comprises a pipette tube comprising a pipette tube proximal end and a pipette tube distal end. The pipette tube proximal end is fixed in the central bore opening at the adapter distal end.

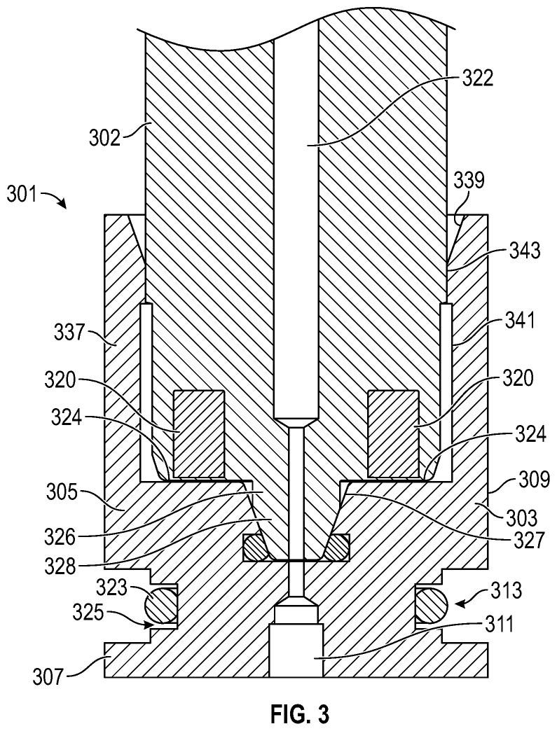

FIG. 3 is a cross-sectional view of part of a pipette tip 301 which is magnetically attached to an aspiration block 302 of a pipettor. The reusable pipette tip 301 has a pipette adapter 303 comprising an adapter proximal end 305, an adapter distal end 307, and an adapter side 309. The adapter radial groove 313 can facilitate storage of pipette tip 301, by providing a feature that can engage a storage device. The compliant material 323 can facilitate placement of the pipette tip 301 in a storage device, compensating and providing flexibility of the adapter radial groove 313 is slightly off its expected position when engaging in storage device. The pipette adapter 303 also comprises an adapter bore 311 which has openings at the adapter proximal end 305 and the adapter distal end 307. The adapter side 309 comprises an adapter radial groove 313 having a compliant material 323 in an adapter subgroove 325. The pipette adapter 303 comprises a magnetically attracted material, and the aspiration block 302 comprises magnets 320 recessed from the aspiration block face 324 which faces the adapter proximal end 305.

In some embodiments, the aspiration block 302 also comprises an extension 326 through which the aspiration channel 322 extends, thereby providing an extended outlet. The extension 326 is adapted to fit within an opening 327 in a pipette tip 301 such that the opening 327 in the pipette tip 301 is in fluid communication with the aspiration channel 322. In some embodiments, the extension 326 comprises a tapered cone 328 extending from the aspiration block face 324, and the aspiration channel 322 extends through the tapered cone 328.

In some embodiments, the adapter bore 311 of the pipette adapter 303 comprises an opening at the adapter distal end 307 which is configured to receive a pipette tube, which can be fixed therein. The pipette tip 301 is magnetically attached to the aspiration tube 302 so as to provide a substantially liquid-tight flow path between the aspiration channel 322 and a pipette tube within the adapter bore 311.

In some embodiments, the pipette adapter 303 further comprises an adapter cup formed by the adapter proximal end 305 and an adapter cup wall 337 extending from the adapter proximal end 305. The adapter cup wall can partially or entirely encircle the adapter proximal end 305. The adapter cup wall 337 can also comprise a cup wall guide 339 opposite the adapter proximal end 305. For example, the cup wall guide 339 can be a sloped surface. The adapter cup wall 337 can also comprise an interior surface 341 and one or more radial rings 343 on the interior surface 341 toward the center.

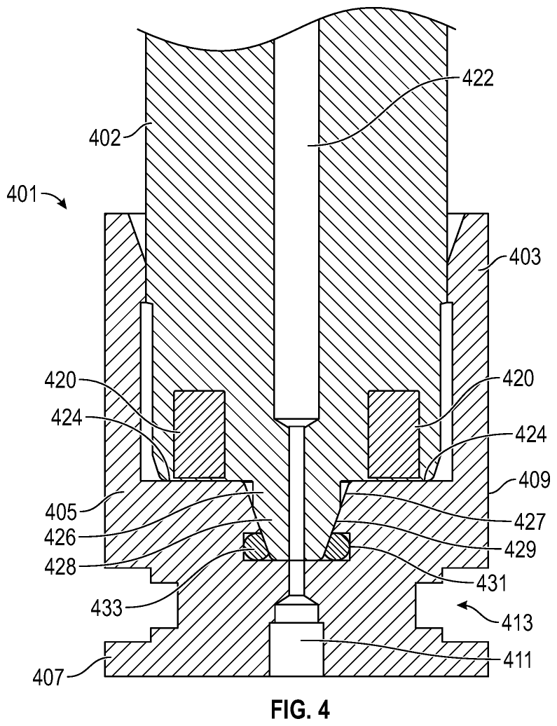

FIG. 4 is an interior view of another embodiment of a pipette tip 401 that is magnetically attached to an aspiration block 402 of a pipettor. The reusable pipette tip 401 comprises a pipette adapter 403 having an adapter proximal end 405, an adapter distal end 407, and an adapter side 409. The pipette adapter 403 also comprises an adapter bore 411 which has openings at the adapter proximal end 405 and the adapter distal end 407. The adapter side 409 comprises an adapter radial groove 413. Unlike pipette tip 301 in FIG. 3, pipette adapter 403 does not include a compliant material in the radial groove 413. Such an embodiment is useful when a storage device is able to compensate for a pipette tip being slightly out of its expected position during storage. The pipette adapter 403 comprises a magnetically attracted material, and the aspiration block 402 comprises magnets 420 recessed from the aspiration block face 424 which faces the adapter proximal end 405.

The aspiration block 402 also comprises an extension 426 that extends into an opening 427 in the pipette adapter 403. The extension 426 comprises a tapered cone 428 extending from the aspiration block face 424. The opening 427 comprises a tapered aperture 429 configured to receive the tapered cone 428. The pipette adapter 403 also comprises an aperture groove 431 at the bottom of the tapered aperture 429, and a compliant seal material 433 such as an O-ring in the aperture groove 431. By including the compliant seal material 433, a radial type seal is provided between the aspiration tube 402 and the pipette adapter 403. The radial seal should be substantially liquid-tight.

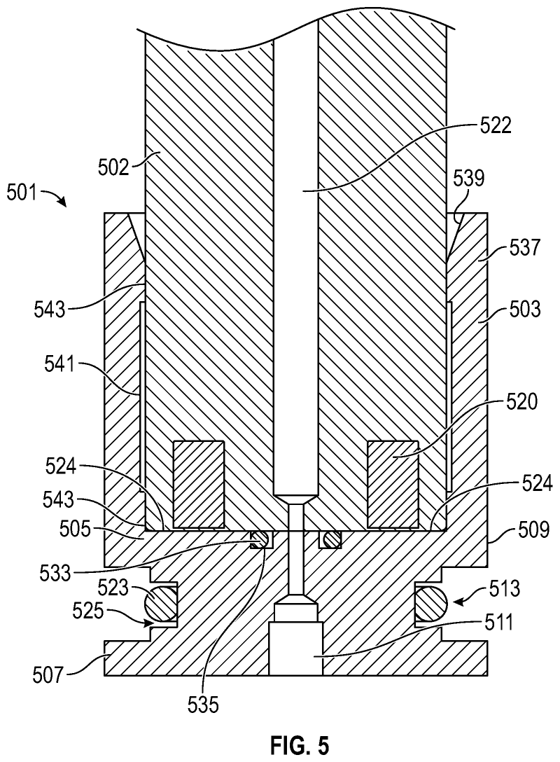

FIG. 5 is a cross-sectional view of yet another embodiment of a pipette tip 501 which is magnetically attached to an aspiration block 502 of a pipettor. The reusable pipette tip 501 comprises a pipette adapter 503 that has an adapter proximal end 505, an adapter distal end 507, and an adapter side 509. The pipette adapter 503 also comprises an adapter bore 511 which has openings at the adapter proximal end 505 and the adapter distal end 507. The pipette tip 501 is magnetically attached to the aspiration tube 502 so as to provide a substantially liquid-tight flow path between the aspiration channel 522 and a pipette tube within the adapter bore 511.

The adapter side 509 comprises an adapter radial groove 513 having a compliant material 523 in an adapter subgroove 525. The pipette adapter 503 comprises a magnetically attracted material, and the aspiration block 502 comprises magnets 520 recessed from the aspiration block face 524 which faces the adapter proximal end 505. The aspiration tube 502 and pipette adapter 503 of FIG. 5 differ from those shown in FIGS. 3 and 4 in that aspiration tube 502 does not include a tapered cone and pipette adapter 503 does not include a tapered aperture. The end of aspiration block 502, or the aspiration block face 524, is substantially flat, and faces a substantially flat adapter proximal end 505. The magnets 520 are slightly recessed from the aspiration block face 524 so that the magnets do not physically contact the pipette adapter 503.

The adapter proximal end 505 comprises an adapter proximal end groove 535 and a compliant seal material 533 (such as an O-ring) in the adapter proximal end groove 535, whereby the compliant seal material provides a static face seal between the aspiration tube 502 and the pipette adapter 503. In some embodiments, the pipette adapter 503 further comprises an adapter cup formed by the adapter proximal end 505 and an adapter cup wall 537 extending from the adapter proximal end 505. The adapter cup wall 537 comprises a cup wall guide 539 opposite the adapter proximal end 505. The adapter cup wall 537 on FIG. 5 comprises two radial rings 543 on the interior surface 541 which engage the aspiration block 502. This embodiment uses closely toleranced radial rings 543 at the top and the bottom of the adapter cup to align the pipette adapter 503. Two radial rings 543, which can be spaced apart, for example by approximately 15 mm, are advantageous to control concentricity and angularity.

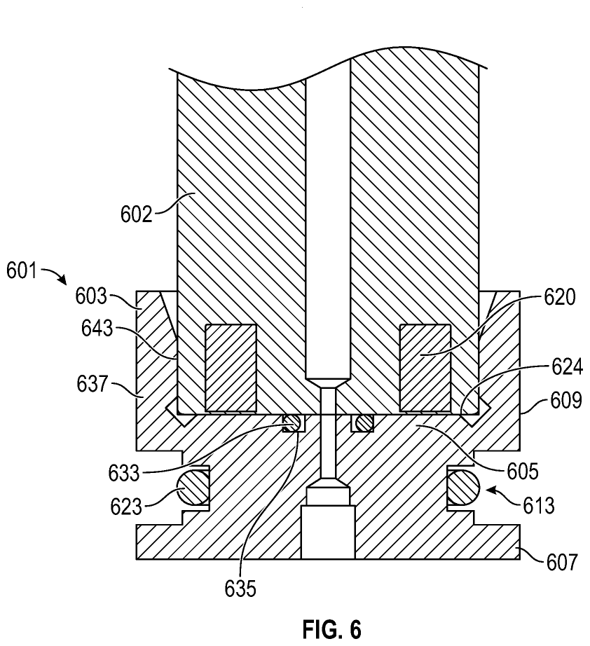

FIG. 6 shows a cross-sectional view of another embodiment of a pipette tip 601 magnetically attached to an aspiration block 602 of a pipettor. The reusable pipette tip 601 comprises a pipette adapter 603 comprising an adapter proximal end 605, an adapter distal end 607, and an adapter side 609. The adapter side 609 comprises an adapter radial groove 613 having a compliant material 623. The pipette adapter 603 comprises a magnetically attracted material, and the aspiration block 602 comprises magnets 620 recessed from the aspiration block face 624 which faces the adapter proximal end 605. The adapter proximal end 605 comprises a compliant seal material 633 (such as an O-ring) in an adapter proximal end groove 635.

The pipette adapter 603 of FIG. 6 further comprises an adapter cup formed by the adapter proximal end 605 and an adapter cup wall 637 extending from the adapter proximal end 605. The pipette adapter 603 of FIG. 6 differs from that shown in FIG. 5 in that the adapter cup wall 637 comprises only one radial ring 643, and the adapter cup wall 637 has a relatively short height. The adapter proximal end 605 also comprises rounded or chamfered edges.

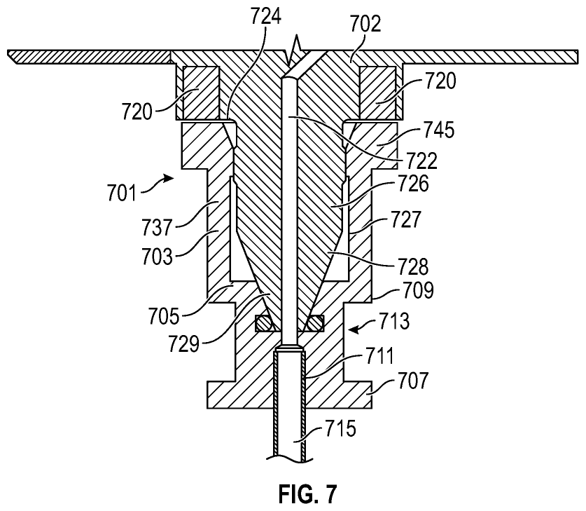

FIG. 7 is a cross-sectional view of an exemplary embodiment of a pipette tip 701 which is magnetically attached to an aspiration block 702 of a pipettor. The reusable pipette tip 701 comprises a pipette adapter 703 comprising an adapter proximal end 705, an adapter distal end 707, and an adapter side 709. The pipette adapter 703 also comprises an adapter bore 711 which has openings at the adapter proximal end 705 and the adapter distal end 707. The adapter side 709 comprises an adapter radial groove 713 which may (or may not) include a compliant material and an adapter subgroove. The pipette adapter 703 comprises a magnetically attracted material, and the aspiration block 702 comprises magnets 720 recessed from the aspiration block face 724 which faces the adapter proximal end 705.

In some embodiments, the aspiration block 702 also comprises an extension 726 through which the aspiration channel 722 extends. The extension 726 is adapted to fit within an opening 727 in a pipette tip 701 such that the opening 727 in the pipette tip 701 is in fluid communication with the aspiration channel 722. In some embodiments, the extension 726 comprises a tapered cone 728 extending from the aspiration block face 724, the opening 727 comprises a tapered aperture 729, and the aspiration channel 722 extends through the tapered cone 728.

In some embodiments, the adapter bore 711 of the pipette adapter 703 comprises an opening at the adapter distal end 707 which is configured to receive a pipette tube 715, which can be fixed therein. The pipette tip 701 is magnetically attached to the aspiration tube 702 so as to provide a substantially liquid-tight flow path between the aspiration channel 722 and a pipette tube 715 within the adapter bore 711.

In some embodiments, the pipette adapter 703 further comprises an adapter cup formed by the adapter proximal end 705 and an adapter cup wall 737 extending from the adapter proximal end 705. Adapter cup wall 737 does not encircle or surround the aspiration block face 724. Instead, the adapter proximal end 705 has a size equal to or smaller than the perimeter of the aspiration block face 724. For example, the adapter proximal end 705 and the aspiration block face 724 each has a perimeter such as a circumference, and the perimeter of adapter proximal end 705 is equal to or smaller than the aspiration block face 724. The adapter cup wall 737 can also comprise a cup wall top 745 that faces aspiration block face 724.

As another aspect, methods are provided for using a reusable pipette tip with a pipettor. The methods can comprise providing a pipettor that has an aspiration block with an aspiration channel and an aspiration block end. The aspiration channel comprises an opening at the aspiration block end. The aspiration block also comprises one or more magnets fixed in the aspiration block at the aspiration block end. The methods can also comprise placing the aspiration block end sufficiently close to a reusable pipette tip to form a magnetic attachment. The reusable pipette tip comprises a pipette adapter comprising a magnetically attracted material, an adapter proximal end, an adapter distal end, and an adapter bore. The reusable pipette tip also comprises a pipette tube that has a pipette tube proximal end and a pipette tube distal end. The pipette tube proximal end is fixed in the central bore opening at the adapter distal end. The pipette tip is magnetically attached to the pipettor so as to provide a substantially liquid-tight flow path between the aspiration channel and the pipette tip channel.

In some embodiments, where the pipette adapter further comprises an adapter side, and the adapter side comprises an adapter radial groove, the method can also include moving the pipettor and the magnetically attached pipette tip to a storage device adapted to receive the pipette adapter; and transferring the pipette adapter to the storage device. In some embodiments, where the storage device comprises an empty storage fork that has storage fork prongs separated by a storage fork mouth, the pipettor is moved so that the magnetically attached pipette tip is inserted into the storage fork mouth in a direction substantially parallel to the storage fork prongs. The method can also comprise moving the pipettor away from the engaged pipette in a direction substantially perpendicular to the storage fork prongs, whereby the magnetic attraction between the magnets in the aspiration body and the pipette adapter is overcome while the storage fork prongs prevent removal of the inserted adapter from the storage fork.

In some embodiments, where the storage device further comprises a second storage fork holding a second pipette tip, the method further comprises moving the pipettor so that the aspiration channel is positioned above the second pipette tip held by the storage fork; moving the pipettor toward the second pipette tip so that the pipettor magnetically attaches the second pipette tip; and moving the pipettor in a direction substantially parallel to the storage fork prongs, thereby removing the second pipette tip from the storage device. The method can also comprise sensing whether the second pipette tip is attached to the aspiration channel before removing the second pipette tip from the storage device.

The present methods and apparatus can also include or be part of methods or systems for preparing samples for analysis. Such systems can include other apparatus to perform other functions. For example, the pipettor can be attached to a gantry for automated movement between different locations (e.g., between a pipette tip storage location and a location of pipette usage (such as a sample processing location, a reagent aspiration location, etc.)). In some embodiments, the present methods and apparatus are including in a liquid handling apparatus that also comprises one or more of a reagent source; a sample processing module; a pipette washing device; or other apparatus.

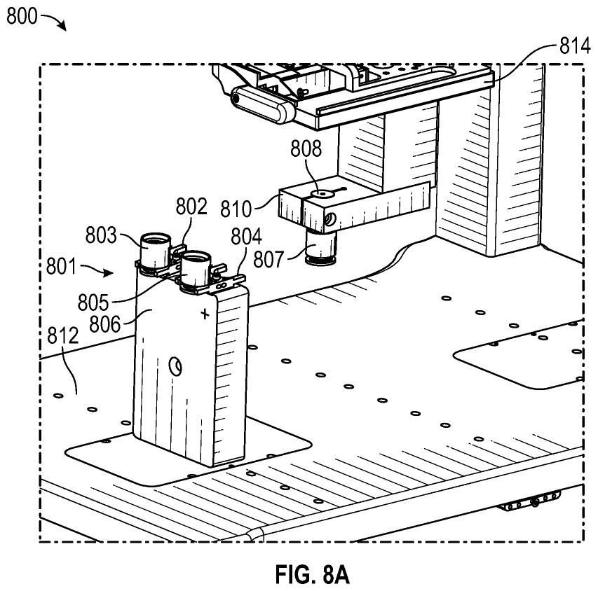

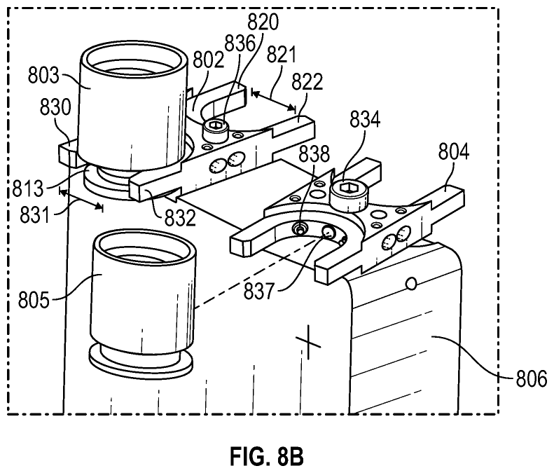

FIGS. 8A and 8B illustrate a pipetting system 800 comprising a pipette tip storage device 801 configured for holding one or more pipette tips. The storage device 800 comprises a plurality of storage forks 802, 804 configured for engaging and holding pipette adapters 803, 805, 807. In some embodiments, the storage forks 802, 804 are configured for receiving pipette adapters 803, 805 at their adapter radial grooves. Storage forks 802, 804 are mounted on a storage block 806. Pipette adapter 807 is magnetically attached at aspiration block connection 808 which is held by aspiration mounting block 810 on a base 812 in the system 800. The system 800 can also comprise a gantry 814 which can move aspiration mounting block 810 to the pipette tip storage device 801 and/or to other devices or locations of pipette usage in the system 800 (such as a sample processing location or device, a reagent aspiration location or device, etc.).

FIG. 8B provides a closer view of storage forks 802, 804 for holding one or more pipette tips. The storage forks 802, 804 are configured for engaging and holding adapter radial grooves of the pipette adapters of reusable pipette tips. Each of the storage forks comprises storage fork prongs separated by a storage fork mouth, and a storage fork can comprise two sets of storage forks and storage fork mouths; for example, storage fork 802 comprises one pair of storage fork prongs 820, 822 separated by a storage fork mouth 821, and another pair of storage fork prongs 830, 832 separated by storage fork mouth 831. The storage fork prongs 830, 832 are configured for receiving an adapter radial groove 813 into the storage fork mouth 831 in a direction substantially parallel to the storage fork prongs 830, 832, and for preventing removal of the inserted pipette adapter 803 from the storage fork 802 in a direction substantially perpendicular to the storage fork prongs 830, 832. Storage fork mouth 831 is wider than a pipette adapter at the adapter radial groove 813 and narrower than the adapter sides 809 adjacent to the adapter radial groove 813.

The storage forks can be rigidly or pivotably mounted on the storage block. For instance, storage fork 802 is rigidly mounted on storage block 806 by a fastener 836. The position of pipette adapter 803 can be established and compensated within the rigid storage fork mouth 831 by an O-ring in adapter radial groove 813. The pipette adapter's locating diameter is smaller than the O-ring's outer diameter. As another example, storage fork 804 is pivotably mounted on storage block 806 by a single fastener 834 in the center of storage fork 804. Pipette adapter 805 is going into storage fork 804; it does not have an O-ring, and its locating diameter is a close fit with the fork. The ability of storage fork 804 to pivot accommodates misalignment in the X or Y directions of the pipette tip by the system. Storage fork 804 comprises a magnet 837 to attract pipette adapter 805 into the storage fork 804. Storage fork 804 also comprises spring plungers 838 to resist horizontal magnet 837 and hold pipette adapter 804 in its nominal position. In some embodiments, the storage device comprises one or more magnets aligned with an opposite pole of the magnet(s) in the storage forks.

It is to be understood that the terminology used herein is for purposes of describing particular embodiments only and is not intended to be limiting. The defined terms are in addition to the technical and scientific meanings of the defined terms as commonly understood and accepted in the technical field of the present teachings.

As used herein, the terms “block” or “body” generally encompasses any structure that comprises one or more channels, such as by a channel formed in a block or body. In some embodiments, a block or body comprises multiple channels, whereby separate fluids may flow through the block or body. In some embodiments, a block or body comprises a manifold in communication with one or more interior flow paths and/or one or more external flow paths.

In some embodiments of the present apparatus, the aspiration block, the pipette adapter, or other components comprise a channel or a tube. The terms “channel” and “tube” generally encompasses any structure configured to define a flow path for fluid to travel. Channels and tubes typically have openings at first and second ends, sometimes referred to as an entrance and an exit in the context of a contemplated flow direction. A channel or a tube can have two or more entrances and/or two or more exits. In some embodiments, a channel is formed in a larger body or a block. In some embodiments, a tube is a conduit inside or outside another component. The geometry of a channel or tube may vary widely and includes circular, rectangular, square, D-shaped, trapezoidal or other polygonal cross-sections.

In some embodiments described above, a surface or interface has a compliant material, such as a compliant material that is substantially fluid-impermeable. In some embodiments, the compliant material is in the form of an O-ring. The compliant material can be any suitable shape or composition. In some embodiments, the compliant material can be a fluoroelastomer material. The compliant material can be various rubbers depending on the fluids used in the devices, for example, fluoropolymers, buna-n, or EPDM. A groove or other feature on an aspiration block, a pipette adapter or other structure can align the compliant material and help to hold the compliant material on the body. The groove depth can be specified to determine how much the compliant material will compress to perform a desired function, such as forming a fluid-tight seal.

In some embodiments, the present apparatus and methods can be configured to move a pipettor or aspiration block between two or more pipettor positions. The pipettor can be changed or switched from one pipettor position to another pipettor position by manual movement, including linear or translational movement, rotational movement, or combinations thereof.

In some embodiments, the present apparatus and methods can comprise a controller such as a data processing unit, a conventional PC or workstation. The controller can be connected to one or more of the present devices in order to receive information and/or control operation. For example, the controller might control operation of the pipettor and receive therefrom information regarding the actual working conditions. The controller might also control operation of the gantry and might receive therefrom information regarding the actual working conditions (such as flow rate, vacuum level, etc.). The controller might further control operation of other devices.

In the present disclosure, the terms “substantial” or “substantially” mean to within acceptable limits or degree to one having ordinary skill in the art. The terms “approximately” and “about” mean to within an acceptable limit or amount to one having ordinary skill in the art. The term “about” generally refers to plus or minus 15% of the indicated number. For example, “about 10” may indicate a range of 8.5 to 11.5. For example, “approximately the same” means that one of ordinary skill in the art considers the items being compared to be the same. When a ranges of values is set forth in the present disclosure, it should be understood that each intervening value, to the tenth of the unit of the lower limit, unless the context clearly dictates otherwise, between the upper and lower limits of that range is also specifically disclosed. Where the stated range includes one or both of the limits, ranges excluding either or both of those included limits are also included in the invention

As used in the specification and appended claims, the terms “a,” “an,” and “the” include both singular and plural referents, unless the context clearly dictates otherwise. Thus, for example, “a conduit” includes one conduit and plural conduits. Unless otherwise indicated, the terms “first”, “second”, “third”, and other ordinal numbers are used herein to distinguish different elements of the present devices and methods, and are not intended to supply a numerical limit. Reference to first and second pipettor positions should not be interpreted to mean that the apparatus only has two pipettor positions. A device having first and second element can also include a third, a fourth, a fifth, and so on, unless otherwise indicated.

Although any methods and materials similar or equivalent to those described herein can also be used in the practice or testing of the present teachings, some exemplary methods and materials are now described. All patents and publications referred to herein are expressly incorporated by reference in their entireties.

### REFERENCES

Powell et al. U.S. Pat. No. 8,168,137
Sheldon U.S. Pat. No. 9,079,178

### EXEMPLARY EMBODIMENTS

Exemplary embodiments provided in accordance with the presently disclosed subject matter include, but are not limited to, the following:

Embodiment 1. A pipettor comprising an aspiration block comprising an aspiration channel and an aspiration block end, wherein the aspiration channel comprises an opening at the aspiration block end; and one or more magnets fixed in the aspiration block at the aspiration block end.

Embodiment 2. The pipettor of embodiment 1, wherein the aspiration block end comprises an aspiration block face configured for magnetic attachment to a pipette tip.

Embodiment 3. The pipettor of embodiment 2, wherein the one or more magnets are recessed from the aspiration block face.

Embodiment 4. The pipettor of any of embodiments 1 to 3, wherein the one or more magnets comprise neodymium iron boron magnets.

Embodiment 5. The pipettor of any of embodiments 1 to 4, wherein the one or more magnets comprise four or more magnets positioned in a circle centered around the aspiration channel.

Embodiment 6. The pipettor of any of embodiments 1 to 5, wherein the aspiration block end comprises an extension through which the aspiration channel extends wherein the extension is adapted to fit within an opening in a pipette tip such that the opening in the pipette tip is in fluid communication with the aspiration channel.

Embodiment 7. The pipettor of embodiment 6, wherein the extension comprises a tapered cone extending from the aspiration block face, and the aspiration channel extends through the tapered cone.

Embodiment 8. The pipettor of any of embodiments 1 to 7, further comprising a pipette tip sensor in the aspiration block end configured to sense whether a pipette tip is attached to the pipettor.

Embodiment 9. A reusable pipette tip comprising:
a pipette adapter comprising an adapter proximal end, an adapter distal end, an adapter side, and an adapter bore having openings at the adapter proximal end and the adapter distal end, wherein:
   the adapter side comprises an adapter radial groove; and
   the pipette adapter comprises a magnetically attracted material; and
a pipette tube comprising a pipette tube proximal end and a pipette tube distal end;
   wherein the pipette tube proximal end is fixed in the central bore opening at the adapter distal end.

Embodiment 10. The reusable pipette tip of embodiment 9, wherein the pipette adapter is cylindrical, and the adapter radial groove entirely encircles the adapter side.

Embodiment 11. The reusable pipette tip of embodiment 9 or 10, wherein the adapter radial groove has a diameter between 6.10 mm and 5.90 mm, a height between 1.60 mm and 1.40 mm, and a distance from a top face of the pipetter adapter between 16.89 mm and 16.87 mm.

Embodiment 12. The reusable pipette tip of any of embodiments 9 to 11, further comprising a compliant material in the adapter radial groove.

Embodiment 13. The reusable pipette tip of embodiment 12, wherein the adapter radial groove comprises an adapter subgroove configured for receiving a portion of the compliant material.

Embodiment 14. The reusable pipette tip of any of embodiments 9 to 13, wherein the magnetically attracted material is selected from stainless steel, 17-4 PH (Heat Treated to Condition H900), and combinations thereof.

Embodiment 15. The reusable pipette tip of any of embodiments 9 to 14, wherein the adapter proximal end comprises rounded or chamfered edges.

Embodiment 16. The reusable pipette tip of any of embodiments 9 to 15, wherein the pipette adapter further comprises an adapter cup formed by the adapter proximal end and an adapter cup wall extending from the adapter proximal end.

Embodiment 17. The reusable pipette tip of embodiment 16, wherein the adapter cup wall partially or entirely encircles the adapter proximal end.

Embodiment 18. The reusable pipette tip of any of embodiments 9 to 17, wherein the adapter cup wall comprises a cup wall guide opposite the adapter proximal end, and the cup wall guide comprises a sloped surface.

Embodiment 19. The reusable pipette tip of any of embodiments 9 to 18, wherein the adapter cup wall comprises an interior surface and a radial ring on the interior surface toward the center.

Embodiment 20. The reusable pipette tip of embodiment 19, wherein the adapter cup wall comprises only one radial ring.

Embodiment 21. The reusable pipette tip of embodiment 19 or 20, the adapter cup wall has a height between 4.01 mm and 3.99 mm.

Embodiment 22. The reusable pipette tip of any of embodiments 9 to 21, wherein the adapter proximal end comprises a tapered aperture surrounding the central bore.

Embodiment 23. The reusable pipette tip of embodiment 22, wherein the tapered aperture comprises an aperture groove and a compliant seal material in the aperture groove.

Embodiment 24. The reusable pipette tip of any of embodiments 9 to 23, wherein the adapter proximal end comprises an adapter proximal end groove and a compliant seal material in the adapter proximal end groove.

Embodiment 25. A pipetting device comprising:
(a) a pipettor comprising:
   an aspiration block comprising an aspiration channel and an aspiration block end, wherein the aspiration channel comprises an opening at the aspiration block end; and
   one or more magnets fixed in the aspiration block at the aspiration block end; and
(b) a reusable pipette tip comprising:
   a pipette adapter comprising an adapter proximal end, an adapter distal end, an adapter side, and an adapter bore having openings at the adapter proximal end and the adapter distal end, wherein:
   the adapter side comprises an adapter radial groove; and
   the pipette adapter comprises a magnetically attracted material; and
   a pipette tube comprising a pipette tube proximal end and a pipette tube distal end;
wherein the pipette tube proximal end is fixed in the central bore opening at the adapter distal end;
   wherein the pipette tip is magnetically attached to the pipettor so as to provide a substantially liquid-tight flow path between the aspiration channel and the pipette tip channel.

Embodiment 26. The pipetting device of embodiment 25, wherein the aspiration block end is substantially flat.

Embodiment 27. The pipetting device of embodiment 25 or 26, wherein the one or more magnets are slightly recessed from the aspiration block face so that the one or more magnets do not physically contact the pipette adapter.

Embodiment 28. The pipetting device of any of embodiments 25 to 27, wherein the pipette adapter further comprises an adapter cup formed by the adapter proximal end and an adapter cup wall extending from the adapter proximal end.

Embodiment 29. The pipetting device of embodiment 28, wherein the adapter cup wall has a radial ring configured to contact and align the pipette adapter with the aspiration channel.

Embodiment 30. The pipetting device of embodiment 28 or 29, wherein the adapter cup wall comprises a cup wall guide opposite the adapter proximal end, and the cup wall guide comprises a sloped surface for guiding the aspiration channel into the adapter cup.

Embodiment 31. The pipetting device of any of embodiments 25 to 27, wherein the adapter proximal end has a size equal to or smaller than the aspiration block end.

Embodiment 32. The pipetting device of any of embodiments 25 to 27 or 31, wherein the adapter proximal end and the aspiration block face each has a perimeter, and the perimeter of adapter proximal end is equal to or smaller than the aspiration block face.

Embodiment 33. A reusable pipette tip system comprising:
a pipetting device according to any of embodiments 25 to 32;
a storage device configured for holding one or more of the pipette tips by engaging the adapter radial grooves of the pipette tips.

Embodiment 34. The system of embodiment 33, wherein the storage device comprises a plurality of storage forks, wherein each of the storage forks comprises storage fork prongs separated by a storage fork mouth, and

the storage fork is configured for receiving the adapter radial groove into the storage fork mouth in a direction substantially parallel to the storage fork prongs, and for preventing removal of the inserted adapter from the storage fork in a direction substantially perpendicular to the storage fork prongs.

Embodiment 35. The system of embodiment 34, wherein the storage fork mouth is wider than the adapter at the adapter radial groove and narrower than the adapter sides adjacent to the adapter radial groove.

Embodiment 36. The system of any of embodiments 33 to 35, wherein the storage device comprises a storage body on which the storage forks are mounted.

Embodiment 37. The system of embodiment 36, wherein the storage forks are pivotably mounted on the storage block.

Embodiment 38. The system of embodiment 37, wherein each of the storage forks comprises one or more spring plungers positioned to push on the adapter radial groove of a pipette adapter inserted in the storage fork.

Embodiment 39. The system of embodiment 36, wherein the storage forks are rigidly mounted on the storage block.

Embodiment 40. The system of any of embodiments 34 to 39, wherein the storage forks comprise one or more magnets positioned to magnetically attract the pipette tip.

Embodiment 41. The system of embodiment 40, wherein the storage device comprises one or more magnets aligned with an opposite pole of the one or more magnets in the storage forks.

Embodiment 42. A method of using a reusable pipette tip with a pipettor, the method comprising:
providing a pipettor comprising an aspiration block comprising an aspiration channel and an aspiration block end, wherein the aspiration channel comprises an opening at the aspiration block end; and one or more magnets fixed in the aspiration block at the aspiration block end; and
placing the aspiration block end sufficiently close to a reusable pipette tip to form a magnetic attachment, wherein the reusable pipette tip comprises:
   a pipette adapter comprising a magnetically attracted material, an adapter proximal end, an adapter distal end, and an adapter bore having openings at the adapter proximal end and the adapter distal end; and
   a pipette tube comprising a pipette tube proximal end and a pipette tube distal end;
wherein the pipette tube proximal end is fixed in the central bore opening at the adapter distal end;
   wherein the pipette tip is magnetically attached to the pipettor so as to provide a substantially liquid tight flow path between the aspiration channel and the pipette tip channel.

Embodiment 43. The method of embodiment 42, wherein the pipette adapter further comprises an adapter side, and the adapter side comprises an adapter radial groove; and the method further comprises:
moving the pipettor and the magnetically attached pipette tip to a storage device adapted to receive the pipette adapter; and
transferring the pipette adapter to the storage device.

Embodiment 44. The method of embodiment 43, wherein the storage device comprises an empty storage fork comprising storage fork prongs separated by a storage fork mouth, wherein the pipettor is moved so that the magnetically attached pipette tip is inserted into the storage fork mouth in a direction substantially parallel to the storage fork prongs; and
moving the pipettor away from the engaged pipette in a direction substantially perpendicular to the storage fork prongs, whereby the magnetic attraction between the one or more magnets in the aspiration body and the pipette adapter is overcome while the storage fork prongs prevent removal of the inserted adapter from the storage fork.

Embodiment 45. The method of embodiment 43, wherein the storage device further comprises a second storage fork holding a second pipette tip, and the method further comprises:
moving the pipettor so that the aspiration channel is positioned above the second pipette tip held by the storage fork;
moving the pipettor toward the second pipette tip so that the pipettor magnetically attaches the second pipette tip; and
moving the pipettor in a direction substantially parallel to the storage fork prongs, thereby removing the second pipette tip from the storage device.

Embodiment 46. The method of embodiment 45, further comprising:
sensing whether the second pipette tip is attached to the aspiration channel before removing the second pipette tip from the storage device.

The foregoing description of exemplary or preferred embodiments should be taken as illustrating, rather than as limiting the present invention as defined by the embodiments. As will be readily appreciated, numerous variations and combinations of the features set forth above can be utilized without departing from the present invention as set forth in the embodiments. Such variations are not regarded as a departure from the scope of the invention, and all such variations are intended to be included within the scope of the following embodiments. All references cited herein are incorporated by reference in their entireties.

1. A pipettor comprising:
an aspiration block comprising an aspiration channel and an aspiration block end, wherein the aspiration channel comprises an opening at the aspiration block end; and
one or more magnets fixed in the aspiration block at the aspiration block end.

2. The pipettor of claim 1, wherein the aspiration block end comprises an aspiration block face configured for magnetic attachment to a pipette tip.

3. The pipettor of claim 2, wherein the one or more magnets are recessed from the aspiration block face.

4. The pipettor of claim 1, wherein the one or more magnets comprise neodymium iron boron magnets.

5. The pipettor of claim 1, wherein the one or more magnets comprise four or more magnets positioned in a circle centered around the aspiration channel.

6. The pipettor of claim 1, wherein the aspiration block end comprises an extension through which the aspiration channel extends wherein the extension is adapted to fit within an opening in a pipette tip such that the opening in the pipette tip is in fluid communication with the aspiration channel.

7. The pipettor of claim 6, wherein the extension comprises a tapered cone extending from the aspiration block face, and the aspiration channel extends through the tapered cone.

8. The pipettor of claim 1, further comprising a pipette tip sensor in the aspiration block end configured to sense whether a pipette tip is attached to the pipettor.

9. A reusable pipette tip comprising:
a pipette adapter comprising an adapter proximal end, an adapter distal end, an adapter side, and an adapter bore having openings at the adapter proximal end and the adapter distal end, wherein:
the adapter side comprises an adapter radial groove; and
the pipette adapter comprises a magnetically attracted material; and
a pipette tube comprising a pipette tube proximal end and a pipette tube distal end;
wherein the pipette tube proximal end is fixed in the central bore opening at the adapter distal end.

10. The reusable pipette tip of claim 9, wherein the pipette adapter is cylindrical, and the adapter radial groove entirely encircles the adapter side.

11. The reusable pipette tip of claim 9, wherein the adapter radial groove has a diameter between 6.10 mm and 5.90 mm, a height between 1.60 mm and 1.40 mm, and a distance from a top face of the pipetter adapter between 16.89 mm and 16.87 mm.

12. The reusable pipette tip of claim 9, further comprising a compliant material in the adapter radial groove.

13. The reusable pipette tip of claim 12, wherein the adapter radial groove comprises an adapter subgroove configured for receiving a portion of the compliant material.

14. The reusable pipette tip of claim 9, wherein the magnetically attracted material is selected from stainless steel, 17-4 PH (Heat Treated to Condition H900), and combinations thereof.

15. The reusable pipette tip of claim 9, wherein the adapter proximal end comprises rounded or chamfered edges.

16. The reusable pipette tip of claim 9, wherein the pipette adapter further comprises an adapter cup formed by the adapter proximal end and an adapter cup wall extending from the adapter proximal end.

17. The reusable pipette tip of claim 16, wherein the adapter cup wall partially or entirely encircles the adapter proximal end.

18. The reusable pipette tip of claim 9, wherein the adapter cup wall comprises a cup wall guide opposite the adapter proximal end, and the cup wall guide comprises a sloped surface.

19. The reusable pipette tip of claim 9, wherein the adapter cup wall comprises an interior surface and a radial ring on the interior surface toward the center.

20-24. (canceled)

25. A pipetting device comprising:
(a) a pipettor comprising:
an aspiration block comprising an aspiration channel and an aspiration block end, wherein the aspiration channel comprises an opening at the aspiration block end; and
one or more magnets fixed in the aspiration block at the aspiration block end; and
(b) a reusable pipette tip comprising:
a pipette adapter comprising an adapter proximal end, an adapter distal end, an adapter side, and an adapter bore having openings at the adapter proximal end and the adapter distal end, wherein:
the adapter side comprises an adapter radial groove; and
the pipette adapter comprises a magnetically attracted material; and
a pipette tube comprising a pipette tube proximal end and a pipette tube distal end;
wherein the pipette tube proximal end is fixed in the central bore opening at the adapter distal end;
wherein the pipette tip is magnetically attached to the pipettor so as to provide a substantially liquid-tight flow path between the aspiration channel and the pipette tip channel.

26-46. (canceled)
